(19) United States
(12) Patent Application Publication
(10) Pub. No.: US 2018/0293814 A1
(43) Pub. Date: Oct. 11, 2018

(54) METHOD TO CLASSIFY SYSTEM PERFORMANCE AND DETECT ENVIRONMENTAL INFORMATION

(71) Applicant: GM Global Technology Operations LLC, Detroit, MI (US)

(72) Inventors: Marcus S. Gilbert, Grass Lake, MI (US); Kevin C. Wong, Canton, MI (US)

(21) Appl. No.: 15/479,850

(22) Filed: Apr. 5, 2017

(51) Int. Cl. G07C 5/08; F02D 41/26; G06N 99/00; G06N 3/08

(52) U.S. Cl. CPC G07C 5/0808; G06N 3/08; G06N 99/005; F02D 41/26

(57) ABSTRACT

A method to determine a status of a motor vehicle includes collecting a first output signal data from at least one device which is outputting the signal data related to a first plurality of operational parameters and a first plurality of environmental parameters of the motor vehicle. The method further includes identifying patterns within the first output signal data, analyzing the patterns within the first output signal data; and generating a second output signal data defining a second plurality of operational parameters distinct from the first operational parameters.

The present disclosure relates to automobile vehicle sensor systems and in particular to methods for collecting and synthesizing data from sensors disposed within automobiles.

Automobiles use a multitude of different types of sensors and actuators. Sensors detect pressure, temperature, position, acceleration, chemical constituent, mass flow, voltage, current and so forth. Actuators include fuel injectors, throttle blades, turbo wastegates, camshaft phasers, spark plugs and spark plug igniters, fuel pumps, exhaust gas recirculation valves, active fuel management, variable lift camshafts, alternators and electrical current modulators, variable geometry turbos and the like. Sensors generally provide data input for automobile control systems, while actuators generally receive data inputs from and provide data outputs in response to automobile control system commands.

Single sensor outputs and actuator outputs can be fed into various control modules within an automobile to help determine engine operating parameters that will improve emissions and/or drivability. Similarly, multiple sensor outputs and actuator outputs can be fed into a variety of control modules within an automobile to help refine engine operating parameters, alter drivability characteristics, and/or respond to certain environmental parameters relating to the automobile.

However, because each of the above noted sensors and actuators provides or responds to only certain types of data, inputs to the various control modules is limited to those certain data types. Thus, while current automotive sensors and actuators achieve their intended purpose, there is a need for new and improved systems and methods for determining additional information from sensors and actuators to further improve fuel economy, automobile emissions, drivability, and noise vibration and harshness characteristics and the like.

### SUMMARY

According to several aspects, a method to determine a status of a motor vehicle includes collecting a first output signal data from at least one device which is outputting the signal data having a first data type relating to first operational parameters of the motor vehicle. The method further includes identifying patterns within the first output signal data, analyzing the patterns within the first output signal data, and generating a second output signal data having a second data type different than the first data type. The second output signal data relates to second operational parameters of the motor vehicle different from the first operational parameters.

In another aspect collecting a first output signal data from at least one device includes collecting the first output from a plurality of sensors and actuators disposed in a motor vehicle.

In still another aspect identifying patterns within the first output signal data and analyzing patterns within the first output signal data includes applying an artificial intelligence program to the first output signal data.

In still another aspect applying the artificial intelligence program includes applying at least one of a reinforcement learning algorithm, a deep machine learning algorithm, a hierarchical learning algorithm, a supervised learning algorithm, a semi-supervised learning algorithm, an unsupervised learning algorithm, a clustering algorithm, a dimensionality reduction algorithm, a structured prediction algorithm, an anomaly detection algorithm, and a neural net algorithm.

In still another aspect generating the second output signal data includes applying the artificial intelligence program to the first output signal data and approximating at least a second device which outputs the second output signal data having the second data type related to the second operational parameters of the motor vehicle.

In still another aspect generating the second output signal further includes applying the artificial intelligence program to indirectly determine ambient environmental conditions applicable to the motor vehicle.

In still another aspect approximating at least a second device further includes simulating at least one virtual sensor or virtual actuator. The at least one virtual sensor or virtual actuator outputs the second output signal data.

In still another aspect approximating at least a second device includes simulating an output of a sensor or an actuator used to determine or respond to environmental conditions applicable to the motor vehicle.

In still another aspect approximating at least a second device includes simulating an output of a sensor or an actuator used to determine or respond to operating conditions applicable to a system equipped to the motor vehicle.

In still another aspect simulating an output of a sensor or an actuator includes simulating an output of a sensor used to determine pressure, temperature, position, acceleration, chemical constituents, mass flow, voltage, or current; or simulating the output of an actuator for a fuel injector, a throttle blade, a turbo wastegate, a camshaft phaser, a spark plug, a fuel pump, an exhaust gas recirculation device, an active fuel management device, a variable lift camshaft, an alternator current, an electrical current, or a variable geometry turbo.

In still another aspect a method for determining a status of a motor vehicle includes collecting a first output signal data from at least one sensor or actuator which is outputting the output signal data related to operational parameters of the motor vehicle. The method further includes identifying patterns within the first output signal data, analyzing the patterns within the first output signal data, identifying when the patterns within the first output signal data indicate a status change, and generating a second output signal data related to the operational parameters of the motor vehicle.

In still another aspect analyzing the patterns within the first output signal data further includes identifying multiple first output signal data sets from the at least one sensor or actuator and applying an artificial intelligence algorithm to the multiple first output signal data sets.

In still another aspect applying the artificial intelligence algorithm further includes applying at least one of a reinforcement learning algorithm, a deep machine learning algorithm, a hierarchical learning algorithm, a supervised learning algorithm, a semi-supervised learning algorithm, an unsupervised learning algorithm, a clustering algorithm, a dimensionality reduction algorithm, a structured prediction algorithm, an anomaly detection algorithm, and a neural net algorithm.

In still another aspect identifying when the patterns within the first output signal data set indicate a status change further includes applying the artificial intelligence algorithm to determine an indirectly detectable second output signal data set.

In still another aspect applying the artificial intelligence algorithm to determine an indirectly detectable second output data set further includes determining indirectly detectable environmental information and motor vehicle status information within the second output signal data set.

In still another aspect generating a second output signal data related to the operational parameters of the motor vehicle further includes simulating at least one virtual sensor or virtual actuator. The at least one virtual sensor or virtual actuator determines or responds to operating conditions applicable to the motor vehicle. The at least one virtual sensor or virtual actuator outputs the second output signal data.

In still another aspect simulating at least one virtual sensor or virtual actuator further includes simulating an output of a sensor used to determine pressure, temperature, position, acceleration, chemical constituents, mass flow, voltage, or current; or simulating the output of an actuator for a fuel injector, a throttle blade, a turbo wastegate, a camshaft phaser, a spark plug, a fuel pump, an exhaust gas recirculation device, an active fuel management device, a variable lift camshaft, an alternator current, an electrical current, or a variable geometry turbo.

In still another aspect a system for determining a status of a motor vehicle includes a plurality of sensors and actuators equipped to the motor vehicle, and an output signal data set collected from at least one of the plurality of sensors and actuators equipped to the motor vehicle. The output data set includes first output signal data related to operational parameters of the motor vehicle. The system further includes an electronic control module in communication with the plurality of sensors and actuators, and a memory. The system further includes a pattern recognition artificial intelligence program stored within the memory of the electronic control module, analyzing the first output signal data, and generating a second output signal data. The system further includes a data classification applied to the second output signal data, and a status signal generated when the second output signal data indicates a status change in the operating parameters of the motor vehicle.

In still another aspect the data classification further includes the second output signal data corresponding to a plurality of virtual sensors and virtual actuators.

In still another aspect the status signal further includes ambient environmental data and operational data related to the motor vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of an internal combustion engine and a control system employing a system and method to classify system performance and detect environmental information according to an aspect of the present disclosure; and

FIG. 2 is a flowchart of the system and method to classify system performance and detect environmental information according to an aspect of the present disclosure.

### DETAILED DESCRIPTION

The following description is merely exemplary in nature and is not intended to limit the present disclosure, application, or uses.

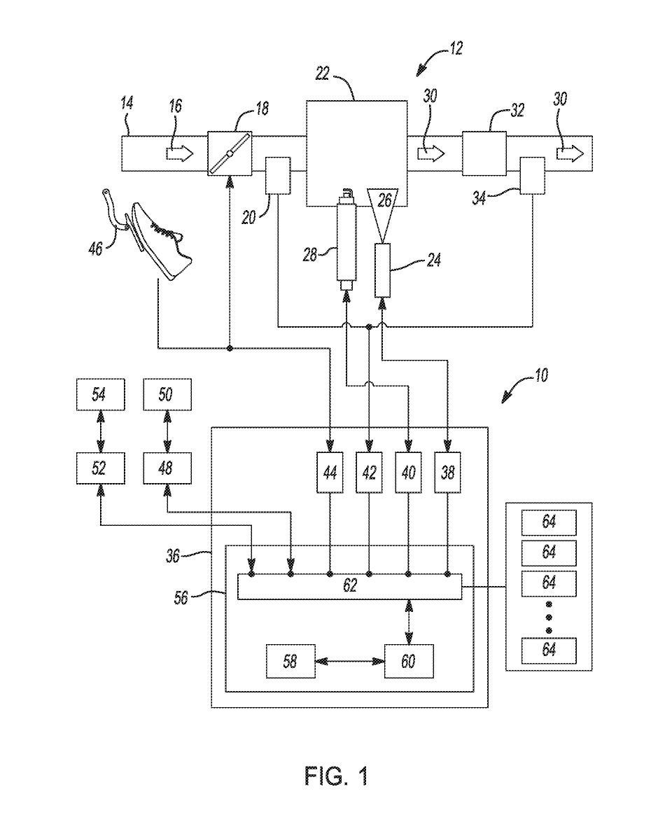

Referring to FIG. 1, a system 10 and method to detect environmental information and classify overall system performance is depicted for use within an exemplary automobile. The system 10 and method in FIG. 1 are applied to an exemplary internal combustion, spark ignition engine 12. The system 10 includes an ambient air intake 14 which feeds ambient air 16 through a throttle actuator 18 past an intake air sensor 20, and into a combustion chamber 22. The intake air sensor 20 determines a quantity of ambient air 16 that is entering the combustion chamber 22. A fuel injector 24 injects fuel as a spray pattern 26 into the combustion chamber 22 where a mixture of the ambient air 16 and fuel is ignited by a spark plug 28. Burned exhaust gas 30 is exhausted from the combustion chamber 22 and passes through at least one catalytic converter 32 as is shown. An exhaust air-fuel ratio (AFR) or O2 sensor 34 is positioned in the flow stream of the burned exhaust gas 30.

While the system 10 and method are depicted and described with respect to an internal combustion spark-ignition engine 12, it should be understood that the system and method can apply to other automobile systems. For example, the system 10 and method can be applied to compression-ignition engines, such as diesel engines, and to electric and hybrid powertrain systems as well without departing from the scope or intent of the present disclosure. Similarly, while the system 10 is depicted and described as having a single O2 sensor 12, ambient air intake 14, throttle actuator 18, combustion chamber 22, fuel injector 24 with spray pattern 26, spark plug 28, and catalytic converter 32, it should be understood that the system 10 may include any combination of the above and in differing quantities than indicated above without departing from the scope or intent of the present disclosure. In an example, an engine 12 having eight-cylinders may include dual ambient air intakes 14, eight throttle actuators 18, dual intake air sensors 20, eight combustion chambers 22, sixteen fuel injectors 24 each with at least one spray pattern 26, and twin spark plugs 28 for each combustion chamber 22. Furthermore, the engine 12 having eight cylinders of the example may also have multiple catalytic converters 32 including light-off catalytic converters (not specifically shown), and secondary catalytic converters (not specifically shown) each with an exhaust AFR sensor 34 prior to each catalytic converter 32, as well as after each catalytic converter 32. In another example, the engine 12 may be a rotary engine with multiple ambient air intakes 14, throttle actuators 18, multiple intake air sensors 20, multiple combustion chambers 22 per rotor (not shown), and multiple fuel injectors 24 with at least one spray pattern 26 each, and multiple spark plugs 28 per combustion chamber 22 without departing from the scope or intent of the present disclosure.

With continued reference to FIG. 1, the system 10 includes an engine control module (ECM) 36 that collects data from a plurality of sensors in the system 10 and generates commands to alter the operating characteristics of the engine 12. The ECM 36 is an embedded controller unit having a plurality of sub-modules, such as a fuel control module 38 in communication with the fuel injector 24 which directs fuel flow through the fuel injector 24. The ECM 36 also includes a spark control module 40 in communication with the spark plug 28, an emissions control module 42 in communication with at least the intake air sensor 20 and the exhaust AFR sensor 34, a throttle control module 44 in communication with the throttle actuator 18 and an accelerator pedal position sensor 46.

In addition to the ECM 36, the system 10 includes a transmission control module (TCM) 48 in communication with a transmission 50, and a body control module (BCM) 52 in communication with a plurality of body control systems 54, such as an immobilizer system, power windows, power mirrors, HVAC systems, and the like. In much the same way as the ECM 36, each of the TCM 48 and the BCM 52 may each include a plurality of sub-modules (not shown), each of which receives data from a plurality of sensors and actuators, and calculates and provides outputs in response to these data without departing from the scope or intent of the present disclosure.

An artificial intelligence compensation module (hereinafter AI module) 56 is embedded within the ECM 36. The AI module 56 is a non-generalized, electronic control device having a preprogrammed digital computer or processor 58 having an artificial intelligence program (hereinafter AI program) saved in random access memory (RAM) memory 60 or non-transitory computer readable medium used to store data, instructions, lookup tables, etc., and a plurality of input/output peripherals or ports 62. The AI module 56 may have additional processors or additional integrated circuits in communication with the processor 58, such as logic circuits for analyzing data, or dedicated AI circuits.

The AI program uses a machine learning algorithm that can perform pattern recognition. AI programs can use a variety of different artificial intelligence algorithms (hereinafter AI algorithms), including, but not limited to: deep machine learning, hierarchical learning, supervised learning, semi-supervised learning, unsupervised learning, clustering, dimensionality reduction, structured prediction, anomaly detection, neural nets, reinforcement learning, and the like. In one aspect, in unsupervised learning, the AI algorithm determines patterns from a stream of input or inputs. In another aspect, an AI algorithm using supervised learning performs classifications to determine to what category a particular input belongs. Additionally, in supervised learning, the AI algorithm attempts to produce a function that describes the relationship between inputs and outputs to predict how outputs should change as the inputs change. In another aspect, an AI algorithm using reinforcement learning rewards “good” behavior, and punishes “bad” behavior, and the AI algorithm uses the sequence of rewards and punishments to form a strategy for operating.

The patterns that are evaluated by the AI program include, but are not limited to, output signal frequency, output signal amplitude, output signal geometry, and the like. For example if an output signal amplitude for a sensor or actuator decreases or increases over time compared to the nominal sensor output signal amplitude saved in the memory 60 or RAM, the AI program identifies first that a change has occurred which exceeds a predetermined threshold, indicating a signal change requiring response, and then identifies how the change itself has altered over time. In an example, an AI program using reinforcement learning collects data from the intake air sensor 20 and the exhaust AFR sensor 34, and based on the constituent components of the exhaust gas 30 and the characteristics of the ambient air 16 drawn past the intake air sensor 20, the AI program determines an additional indirectly-sensed environmental condition. In the example, the AI program determines an ambient humidity, and a barometric pressure.

In another example in which the AI program collects data from the intake air sensor 20 and the exhaust AFR sensor 34, as the exemplary automobile climbs a mountain, an air density and a temperature of the ambient air 16 each decrease. The AI program identifies that a change has occurred in ambient air 16 flow past the intake air sensor 20 as well as exhaust constituents within the burned exhaust gas 30 and determines that due to the change in the ambient air 16 flow and exhaust constituents, the automobile is at an increased altitude, relative to sea level.

Thus, the AI program can determine additional information from existing data, and thereby emulate a plurality of artificial or virtual sensors 64. In one aspect, each of the plurality of virtual sensors 64 generated by the AI program can indirectly determine environmental data, engine 12 system data, and the like. Each of the environmental data, and the engine 12 system data are used by the ECM 36 to provide additional refinements to the directly-sensed data upon which the ECM 36 bases commands for the engine 12, transmission, HVAC system, and the like. While the AI program is described above as determining ambient humidity, barometric pressure, and altitude, it should be understood that depending on what types of sensors are equipped in the system 10, the types of virtual sensors 64 that may be emulated will vary. Exemplary virtual sensors 64 for a system 10 equipped with the plurality of sensors and actuators depicted in FIG. 1 may include fuel ethanol content (ETON) sensors, altitude sensors, humidity sensors, evaporation leak sensors, shift quality sensors, driver aggressiveness sensors, and the like without departing from the scope or intent of the present disclosure.

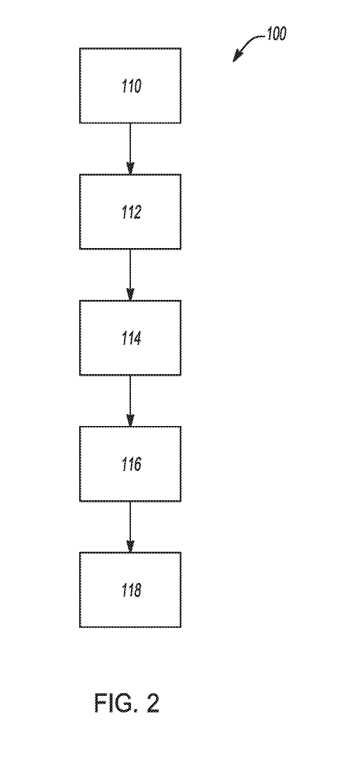

Referring now to FIG. 2 and with continuing reference to FIG. 1, a simplified depiction of a method in which the system 10 operates is depicted. The method is generally indicated by reference number 100. The method 100 begins at a block 110 where the system 10 collects operating data from a plurality of sensors and actuators disposed on a motor vehicle. At a block 112, the operating data from the plurality of sensors and actuators is fed into an on-board embedded control unit, or embedded controller, such as an ECM 36, a TCM 48, or a BCM 52. At a block 114, an AI program stored within the memory 60 of the embedded control unit analyzes the operating data by applying an AI algorithm to the operating data to identify patterns within the operating data. At a block 116, the AI program identifies when the patterns within the operating data indicate that the status of the motor vehicle has changed or is changing. At a block 118, the method 100 generates output data that can be used by a variety of systems within the motor vehicle to refine automobile system responses. In one aspect, the output data simulates the plurality of virtual sensors 64, including but not limited to: fuel ETOH sensors, altitude sensors, humidity sensors, evaporation leak sensors, shift quality sensors, driver aggressiveness sensors, and the like.

The system 10 and method 100 to classify system performance and detect environmental information of the present disclosure offer several advantages. The use of pattern recognition provided by the AI program can be applied to sensor and actuator output data patterns. By reviewing patterns of data output from various sensors and actuators, improvements can be made in data recognition and sensor and actuator operation, and the like. The improvements include application to sensors used to determine indirectly-detectable pressure, temperature, position, acceleration, chemical constituent, mass flow, voltage, current and the like. The method 100 to classify system performance and detect environmental information of the present disclosure can similarly be applied to actuators used in automobiles, including actuators used for the fuel injector 26, throttle actuator 18, turbo wastegate, camshaft phasers, spark plug 28, fuel pump, exhaust gas 30 recirculation, active fuel management, variable lift camshaft, alternator and electrical current, variable geometry turbo and the like. Moreover, the system 10 and method 100 can be applied to virtually increase the quantity and variety of sensors equipped to an automobile while reducing the hardware costs of the physical sensors equipped to the automobile.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method to determine a status of a motor vehicle, the method comprising:
collecting a first output signal data from at least one device which is outputting the signal data having a first data type relating to first operational parameters of the motor vehicle;
identifying patterns within the first output signal data;
analyzing the patterns within the first output signal data; and
generating a second output signal data having a second data type different than the first data type, and wherein the second output signal data relates to second operational parameters of the motor vehicle different from the first operational parameters.

2. The method of claim 1 wherein collecting a first output signal data from at least one device comprises collecting the first output signal data from a plurality of sensors and actuators disposed in a motor vehicle selected from the group consisting of an intake air sensor, an exhaust sensor, a throttle actuator, an accelerator pedal position sensor, an ethanol content (ETON) sensor, an altitude sensor, a humidity sensor, an evaporation leak sensor, a shift quality sensor, and a driver aggressiveness sensor.

3. The method of claim 1 wherein identifying patterns within the first output signal data and analyzing patterns within the first output signal data comprises applying an artificial intelligence program to the first output signal data.

4. The method of claim 3 wherein the applying the artificial intelligence program comprises applying at least one of a reinforcement learning algorithm, a deep machine learning algorithm, a hierarchical learning algorithm, a supervised learning algorithm, a semi-supervised learning algorithm, an unsupervised learning algorithm, a clustering algorithm, a dimensionality reduction algorithm, a structured prediction algorithm, an anomaly detection algorithm, and a neural net algorithm.

5. The method of claim 3 wherein generating the second output signal data comprises applying the artificial intelligence program to the first output signal data and approximating at least a second device which outputs the second output signal data having the second data type related to the second operational parameters of the motor vehicle.

6. The method of claim 5 wherein generating the second output signal further includes applying the artificial intelligence program to indirectly determine ambient environmental conditions applicable to the motor vehicle.

7. The method of claim 5 wherein approximating at least a second device further comprises simulating at least one virtual sensor or virtual actuator, and wherein the at least one virtual sensor or virtual actuator outputs the second output signal data.

8. The method of claim 5 wherein approximating at least a second device comprises simulating an output of a sensor or an actuator used to determine or respond to environmental conditions applicable to the motor vehicle.

9. The method of claim 5 wherein approximating at least a second device comprises simulating an output of a sensor or an actuator used to determine or respond to operating conditions applicable to a system equipped to the motor vehicle.

10. The method of claim 9 wherein simulating an output of a sensor or an actuator comprises:
simulating an output of a sensor used to determine pressure, temperature, position, acceleration, chemical constituents, mass flow, voltage, or current; or
simulating the output of an actuator for a fuel injector, a throttle blade, a turbo wastegate, a camshaft phaser, a spark plug, a fuel pump, an exhaust gas recirculation device, an active fuel management device, a variable lift camshaft, an alternator current, an electrical current, or a variable geometry turbo.

11. A method for operating a motor vehicle, the method comprising:
collecting a first output signal data from at least one sensor or actuator which is outputting the output signal data related to operational parameters of the motor vehicle;
identifying patterns within the first output signal data;
analyzing the patterns within the first output signal data;
identifying when the patterns within the first output signal data indicate a status change;
generating a second output signal data related to the operational parameters of the motor vehicle; and
commanding, by an electronic control module in the motor vehicle, at least one of an engine, a transmission, and an HVAC system in the motor vehicle based on the second output signal.

12. The method of claim 11, wherein analyzing the patterns within the first output signal data further comprises identifying multiple first output signal data sets from the at least one sensor or actuator and applying an artificial intelligence algorithm to the multiple first output signal data sets.

13. The method of claim 12 wherein the applying the artificial intelligence algorithm further comprises applying at least one of a reinforcement learning algorithm, a deep machine learning algorithm, a hierarchical learning algorithm, a supervised learning algorithm, a semi-supervised learning algorithm, an unsupervised learning algorithm, a clustering algorithm, a dimensionality reduction algorithm, a structured prediction algorithm, an anomaly detection algorithm, and a neural net algorithm.

14. The method of claim 12, wherein identifying when the patterns within the first output signal data set indicate a status change further comprises applying the artificial intelligence algorithm to determine an indirectly detectable second output signal data set.

15. The method of claim 14, wherein applying the artificial intelligence algorithm to determine an indirectly detectable second output data set further includes determining indirectly detectable environmental information and motor vehicle status information within the second output signal data set.

16. The method of claim 11, wherein generating a second output signal data related to the operational parameters of the motor vehicle further comprises simulating at least one virtual sensor or virtual actuator, wherein the at least one virtual sensor or virtual actuator determines or responds to operating conditions applicable to the motor vehicle, and wherein the at least one virtual sensor or virtual actuator outputs the second output signal data.

17. The method of claim 16 wherein simulating at least one virtual sensor or virtual actuator further comprises:
simulating an output of a sensor used to determine pressure, temperature, position, acceleration, chemical constituents, mass flow, voltage, or current; or
simulating the output of an actuator for a fuel injector, a throttle blade, a turbo wastegate, a camshaft phaser, a spark plug, a fuel pump, an exhaust gas recirculation device, an active fuel management device, a variable lift camshaft, an alternator current, an electrical current, or a variable geometry turbo.

18. A system for determining a status of a motor vehicle, the system comprising:
a plurality of sensors and actuators equipped to the motor vehicle;
an output signal data set collected from at least one of the plurality of sensors and actuators equipped to the motor vehicle, wherein the output data set includes first output signal data related to operational parameters of the motor vehicle;
an electronic control module in communication with the plurality of sensors and actuators, and having a memory;
a pattern recognition artificial intelligence program stored within the memory of the electronic control module, analyzing the first output signal data, and generating a second output signal data;
a data classification applied to the second output signal data; and
a status signal generated when the second output signal data indicates a status change in the operating parameters of the motor vehicle.

19. The system of claim 18 wherein the data classification further comprises the second output signal data corresponding to a plurality of virtual sensors and virtual actuators.

20. The system of claim 19 wherein the status signal further comprises ambient environmental data and operational data related to the motor vehicle.
